(19) United States
(12) Patent Application Publication
(10) Pub. No.: US 2023/0169030 A1
(43) Pub. Date: Jun. 1, 2023

(54) APPARATUS FOR READ/WRITE OPERATIONS ON SAS HARD DISK THROUGH USB INTERFACE

(71) Applicant: Shenzhen Hengxinyuan Technology Co., Ltd, Shenzhen (CN)

(72) Inventors: Tao Rong, Shenzhen (CN); Yulin Feng, Shenzhen (CN); Zhiqiang Wang, Shenzhen (CN); Xiaobing Jiang, Shenzhen (CN)

(21) Appl. No.: 17/553,792

(22) Filed: Dec. 16, 2021

(30) Foreign Application Priority Data
Nov. 29, 2021 (CN) 202122977794.5

(51) Int. Cl. G06F 13/42; G06F 13/38; G06F 13/40; G06F 1/20

(52) U.S. Cl. CPC G06F 13/4282; G06F 13/385; G06F 13/4068; G06F 13/409; G06F 13/4234; G06F 1/206

(57) ABSTRACT

The present disclosure discloses an apparatus for read/write operations on a serial attached small computer system interface (SAS) hard disk through a universal serial bus (USB) interface. The apparatus includes: a case, where the case is internally provided with a printed circuit board assembly (PCBA) mainboard, the PCBA mainboard is provided with a controller, a power management module, an SAS to serial advanced technology attachment (SATA) protocol conversion module, an SATA to USB protocol conversion module, a USB interface and an SAS hard disk access interface, and the controller controls the PCBA mainboard to conduct the read/write operations on the SAS hard disk; and other components. The apparatus facilitates rapid read/write operations on the SAS hard disk by a consumer through the USB interface, and also improves heat dissipation efficiency of an apparatus body.

### CROSS REFERENCE TO RELATED APPLICATIONS

The present application claims the benefit of Chinese Patent Application No. 202122977794.5 filed on Nov. 29, 2021, the contents of which are incorporated herein by reference in their entirety.

### TECHNICAL FIELD

The present disclosure relates to the technical field of read/write devices for serial attached small computer system interface (SAS) hard disks, and in particular to an apparatus for read/write operations on an SAS hard disk through a universal serial bus (USB) interface.

### BACKGROUND ART

A serial attached small computer system interface (SAS) hard disk usually uses an SAS interface to be in communication with a computer mainboard. But read/write operations on data of the SAS hard disk through the SAS interface of the mainboard have become increasingly complex for meeting various requirements of consumers.

During data conversion by an adapter, increase in read/write amount and prolongation of read/write time cause increase in heat of a chip in the adapter, rendering an adapter body overheated, and even resulting in adapter failure due to overheating. Some adapters lower a read/write speed to be cooled when being at high temperature, which also imposes a degraded actual use experience on consumers.

Therefore, an apparatus for read/write operations on an SAS hard disk through a universal serial bus (USB) interface is urgently needed for solving one or more of the problems.

### SUMMARY OF THE INVENTION

In order to solve one or more problems in the prior art, the present disclosure provides an apparatus for read/write operations on a serial attached small computer system interface (SAS) hard disk through a universal serial bus (USB) interface. The technical solution used in the present disclosure for solving the problems is an apparatus for read/write operations on an SAS hard disk through a USB interface. The apparatus includes: a case, where the case is internally provided with a printed circuit board assembly (PCBA) mainboard, the PCBA mainboard is provided with a controller, a power management module, an SAS to serial advanced technology attachment (SATA) protocol conversion module, an SATA to USB protocol conversion module, a USB interface and an SAS hard disk access interface, and the controller controls the PCBA mainboard to conduct the read/write operations on the SAS hard disk.

Furthermore, the case is provided with an indicator light, a power interface and a button which are electrically connected to the PCBA mainboard.

Furthermore, the case includes: a bottom case, a top case and a heat dissipation case;
the bottom case is provided with a mounting recess, the PCBA mainboard is mounted in the mounting recess, and a side wall of the bottom case is provided with a clamping groove;
a bottom of the top case is provided with a protrusion matching the clamping groove, the top case is provided with a through groove penetrating through the protrusion, and the top case is mounted on the bottom case;
a bottom of the heat dissipation case is provided with a connecting protrusion, the connecting protrusion matches the through groove in shape and size, and the heat dissipation case is mounted on the top case; and
several heat conduction silica gel pads are attached to the PCBA mainboard, and the heat conduction silica gel pads make close contact with the connecting protrusion.

Furthermore, the mounting recess is internally provided with several stand columns, and the PCBA mainboard is mounted on the stand columns.

Furthermore, the clamping grooves are provided on tops of two symmetrical side walls of the bottom case correspondingly.

Furthermore, a top of the heat dissipation case is provided with a flange or a slot, and the flange and the slot are configured to improve heat dissipation efficiency.

Furthermore, the controller, the power management module, the SAS to SATA protocol conversion module and the SATA to USB protocol conversion module are integrated on the same chip.

The present disclosure has the beneficial effects that the present disclosure connects the PCBA mainboard, the bottom case, the top case, the heat dissipation case, the heat conduction silica gel pads and other components together by means of an ingenious structure, thus conducting the read/write operations on the SAS hard disk through the USB interface, so as to facilitate usage of a consumer; moreover, the heat dissipation case and the heat conduction silica gel pads are arranged to improve the heat dissipation efficiency of the apparatus, so that speed reduction caused by overheating is avoided, service life of the internal chip is prolonged; the heat dissipation case is capable of making close contact with an uneven top of the chip by means of the heat conduction silica gel pads and achieving insulation, and then heat conduction efficiency is effectively improved and short circuit due to metal contact is prevented; and the stand columns are arranged to form a cavity in a bottom of the PCBA mainboard after the PCBA mainboard is mounted, and the cavity generates convection by means of a gap at an interface to conduct heat dissipation on the bottom of the PCBA mainboard, so that mounting of a mainboard is facilitated. Practical value of the present disclosure is greatly improved through the above.

### DESCRIPTION OF THE DRAWINGS

FIG. 1 is a schematic diagram I of the present disclosure;

FIG. 2 is a schematic diagram II of the present disclosure; and

FIG. 3 is an explosive view of the present disclosure.

### REFERENCE NUMERALS

101 . . . Bottom case

102 . . . Mounting recess

103 . . . Stand column

104 . . . Clamping groove

110 . . . Button

111 . . . Indicator light

201 . . . PCBA mainboard

202 . . . USB interface

203 . . . Power interface

204 . . . SAS hard disk access interface

210 . . . Heat conduction silica gel pad

301 . . . Top case

302 . . . Protrusion

303 . . . Through groove

401 . . . Heat dissipation case

402 . . . Connecting protrusion

403 . . . Flange

### DETAILED DESCRIPTION OF THE EMBODIMENTS

In order to make the above objectives, features and advantages of the present disclosure more apparent and easily understood, specific embodiments of the present disclosure will be described in detail below with reference to the accompanying drawings. Many specific details are set forth in the following description to facilitate full understanding of the present disclosure. However, the present disclosure may be implemented in many other modes different from those described herein, similar improvements may be made by those skilled in the art without departing from the connotation of the present disclosure, and therefore the present disclosure is not limited by the specific embodiments disclosed below.

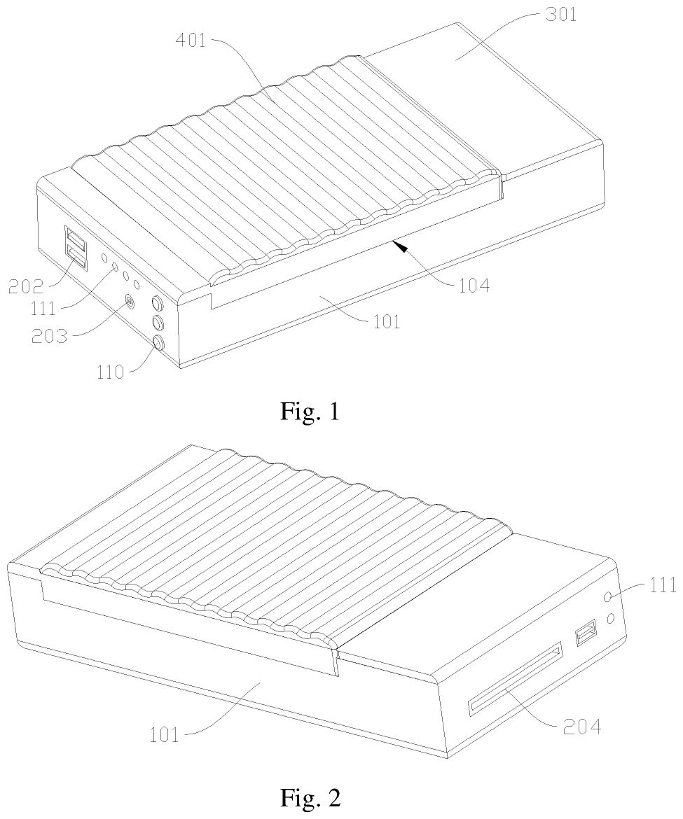

As shown in FIGS. 1-3, the present disclosure discloses an apparatus for read/write operations on a serial attached small computer system interface (SAS) hard disk through a universal serial bus (USB) interface. The apparatus includes: a case, where the case is internally provided with a printed circuit board assembly (PCBA) mainboard 201, the PCBA mainboard 201 is provided with a controller, a power management module, an SAS to serial advanced technology attachment (SATA) protocol conversion module, an SATA to USB protocol conversion module, a USB interface 202 and an SAS hard disk access interface 204, and the controller controls the PCBA mainboard 201 to conduct the read/write operations on the SAS hard disk.

It should be noted that the case is provided with an indicator light 111, a power interface 203 and a button 110 which are electrically connected to the PCBA mainboard 201. The apparatus may be supplied with power by means of the USB interface 202 or the power interface 203. Generally, the controller, the power management module, the SAS to SATA protocol conversion module and the SATA to USB protocol conversion module are integrated on the same chip.

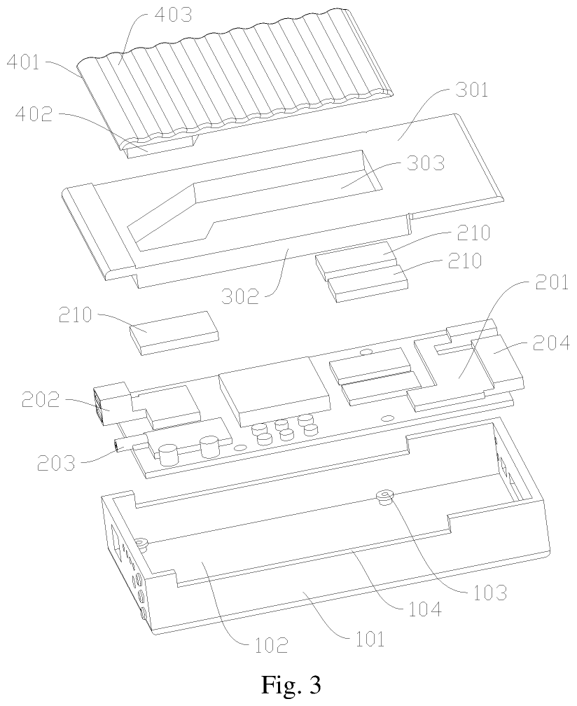

As shown in FIG. 3, the case includes: a bottom case 101, a top case 301 and a heat dissipation case 401; the bottom case 101 is provided with a mounting recess 102, the PCBA mainboard 201 is mounted in the mounting recess 102, and a side wall of the bottom case 101 is provided with a clamping groove 104;
a bottom of the top case 301 is provided with a protrusion 302 matching the clamping groove 104, the top case 301 is provided with a through groove 303 penetrating through the protrusion 302, and the top case 301 is mounted on the bottom case 101;
a bottom of the heat dissipation case 401 is provided with a connecting protrusion 402, the connecting protrusion 402 matches the through groove 303 in shape and size, and the heat dissipation case 401 is mounted on the top case 301; and
several heat conduction silica gel pads 210 are attached to the PCBA mainboard 201, and the heat conduction silica gel pads 210 make close contact with the connecting protrusion 402.

Specifically, as shown in FIG. 3, the mounting recess 102 is internally provided with several stand columns 103, and the PCBA mainboard 201 is mounted on the stand columns 103. The clamping grooves 104 are provided on tops of two symmetrical side walls of the bottom case 101 correspondingly. A top of the heat dissipation case 401 is provided with a flange 403 or a slot, the flange 403 and the slot are configured to improve heat dissipation efficiency, and edges and corners the flange 403 and the slot are chamfered or rounded.

It should be noted that the bottom case 101 and the top case 301 are usually made of plastic, the heat dissipation case 401 is usually made of metal with excellent heat conduction property such as aluminum, aluminum alloy, copper and copper alloy, and the heat conduction silica gel pads 210 are made of insulating and high-heat-conductivity silica gel sheets with excellent heat conduction property. A cavity formed between the stand columns 103 and the PCBA mainboard 201 directly faces the USB interface 202 and/or the SAS hard disk access interface 204, the case may further be provided with a heat dissipation hole, and the heat dissipation hole matches the cavity formed between the stand columns 103 and the PCBA mainboard 201.

In conclusion, the present disclosure connects the PCBA mainboard 201, the bottom case 101, the top case 301, the heat dissipation case 401, the heat conduction silica gel pads 210 and other components together by means of an ingenious structure, thus conducting the read/write operations on the SAS hard disk through the USB interface, so as to facilitate usage of a consumer; moreover, the heat dissipation case and the heat conduction silica gel pads are arranged to improve the heat dissipation efficiency of the apparatus, so that speed reduction caused by overheating is avoided, service life of the internal chip is prolonged; the heat dissipation case is capable of making close contact with an uneven top of the chip by means of the heat conduction silica gel pads and achieving insulation, and then heat conduction efficiency is effectively improved and short circuit due to metal contact is prevented; and the stand columns are arranged to form a cavity in a bottom of the PCBA mainboard after the PCBA mainboard is mounted, and the cavity generates convection by means of a gap at an interface to conduct heat dissipation on the bottom of the PCBA mainboard, so that mounting of a mainboard is facilitated. Practical value of the present disclosure is greatly improved through the above.

The above embodiments are merely one or more embodiments of the present disclosure, and are specifically described in details, but may not be interpreted as limiting the patent for the present disclosure as a result. It should be noted that for those of ordinary skill in the art, they may also make several transformations and improvements on the premise of not deviating from the conception of the present disclosure, and these transformations and improvements shall fall within the scope of protection of the present disclosure. Hence, the scope of protection of the present disclosure should be subject to the appended claims.

What is claimed is:

1. An apparatus for read/write operations on a serial attached small computer system interface (SAS) hard disk through a universal serial bus (USB) interface, comprising: a case, wherein the case is internally provided with a printed circuit board assembly (PCBA) mainboard, the PCBA mainboard is provided with a controller, a power management module, an SAS to serial advanced technology attachment (SATA) protocol conversion module, an SATA to USB protocol conversion module, a USB interface and an SAS hard disk access interface, and the controller controls the PCBA mainboard to conduct the read/write operations on the SAS hard disk.

2. The apparatus for read/write operations on an SAS hard disk through a USB interface according to claim 1, wherein the case is provided with an indicator light, a power interface and a button which are electrically connected to the PCBA mainboard.

3. The apparatus for read/write operations on an SAS hard disk through a USB interface according to claim 1, wherein the case comprises:
a bottom case, a top case and a heat dissipation case;
the bottom case is provided with a mounting recess, the PCBA mainboard is mounted in the mounting recess, and a side wall of the bottom case is provided with a clamping groove;
a bottom of the top case is provided with a protrusion matching the clamping groove, the top case is provided with a through groove penetrating through the protrusion, and the top case is mounted on the bottom case;
a bottom of the heat dissipation case is provided with a connecting protrusion, the connecting protrusion matches the through groove in shape and size, and the heat dissipation case is mounted on the top case; and
several heat conduction silica gel pads are attached to the PCBA mainboard, and the heat conduction silica gel pads make close contact with the connecting protrusion.

4. The apparatus for read/write operations on an SAS hard disk through a USB interface according to claim 3, wherein the mounting recess is internally provided with several stand columns, and the PCBA mainboard is mounted on the stand columns.

5. The apparatus for read/write operations on an SAS hard disk through a USB interface according to claim 3, wherein the clamping grooves are provided on tops of two symmetrical side walls of the bottom case correspondingly.

6. The apparatus for read/write operations on an SAS hard disk through a USB interface according to claim 3, wherein a top of the heat dissipation case is provided with a flange or a slot, and the flange and the slot are configured to improve heat dissipation efficiency.

7. The apparatus for read/write operations on an SAS hard disk through a USB interface according to claim 1, wherein the controller, the power management module, the SAS to SATA protocol conversion module and the SATA to USB protocol conversion module are integrated on a same chip.
